(19) United States
(12) Patent Application Publication
(10) Pub. No.: US 2025/0343474 A1
(43) Pub. Date: Nov. 6, 2025

(54) POSITION FEEDBACK UTILIZING AXIAL LEAKAGE FLUX IN RADIAL FLUX MOTORS

(71) Applicant: Omni Powertrain Technologies, LLC, Houston, TX (US)

(72) Inventors: Nick Woinarowicz, Houston, TX (US); Aakash Mishra, Houston, TX (US); Levent U. Gokdere, Houston, TX (US)

(21) Appl. No.: 18/981,101

(22) Filed: Dec. 13, 2024

Related U.S. Application Data
(60) Provisional application No. 63/640,945, filed on May 1, 2024.

(51) Int. Cl. H02K 11/215; H02K 11/01; H02K 21/16; H02P 6/16

(52) U.S. Cl. CPC H02K 11/215; H02K 11/0141; H02K 21/16; H02P 6/16; H02K 2211/03; H02P 2207/05

(57) ABSTRACT

A radial flux motor assembly has a motor housing enclosing a rotor assembly mounted on a motor shaft and a stator assembly mounted radially outward of the rotor assembly. The rotor assembly includes permanent magnets producing a first magnetic flux. The stator assembly includes an electromagnet producing a second magnetic flux. The angular position of the motor shaft can be determined at any time during operation of the radial flux motor using a sensor assembly mounted along the motor shaft and spaced axially apart from the rotor assembly and radially inward of the stator assembly. The sensor assembly includes at least one hall effect sensor which is fixed relative to the housing to be within the first magnetic flux and substantially outside of the second magnetic flux in order to detect a first magnetic flux axial component propagating parallel to the motor shaft.

### CROSS-REFERENCE TO RELATED APPLICATION

This application claims the benefit of priority to U.S. Provisional Application No. 63/640,945, filed May 1, 2024, the benefit of which is claimed and the disclosure of which is incorporated by reference in its entirety.

### FIELD OF THE DISCLOSURE

The present disclosure relates, in general, to permanent magnet radial flux motors, and more particularly, to apparatuses, systems, and methods for determining and monitoring the angular position of a driveshaft of a permanent magnet radial flux motor.

### BACKGROUND

A conventional permanent magnet synchronous radial flux motor is constructed with stationary electromagnetic coils disposed radially outward of a primary rotor containing corresponding permanent magnets and mounted on a driveshaft. These motors send primary rotor position feedback to a motor controller to indicate the angular position of the driveshaft. This position feedback is commonly accomplished using one or more sense magnets of a sense magnet rotor mounted adjacent the primary rotor permanent magnets, where the sense magnets and primary rotor permanent magnets are aligned with each other to have the same angular displacement. Both the main permanent magnets and the sense magnets may be mounted on the same rotor, but are separated from each other axially, typically from 15-50 millimeters. This spacing for the sense magnets is introduced to prevent interference of the stator magnetic flux with the sense magnets. As such, the sense magnets and their typical arrangement add both weight and length to conventional radial flux electric motors.

To maximize operation of a radial flux electric motor, the motor controller needs to know the precise angular displacement of this sense magnet or sense magnet rotor with respect to the main permanent magnets in the primary rotor. In the prior art, this is typically accomplished in one of two ways in conventional radial flux electric motors. One way is through the motor manufacturing process by placing the sense magnets in a repeatable fixed location on the rotating shaft, which fixed location is programmed into the controller. The other way is to employ a feature in the controller that will go through a routine at the system commissioning to calibrate the controller to this positioning. Neither of these typical methods is ideal, as each has associated complexities and costs, i.e., time, money, quality assurance, etc. Thus, it would be desirable to be able to determine the angular position of the driveshaft of an electric motor without the use of sense magnets.

### BRIEF DESCRIPTION OF THE DRAWINGS

FIG. 1 illustrates a radial flux motor assembly including a first portion of a motor housing, a motor shaft, a rotor assembly, and a sensor assembly.

FIG. 2 illustrates the radial flux motor assembly of FIG. 1 with the rotor assembly removed to better illustrate the sensor assembly.

FIG. 3 illustrates the radial flux motor assembly of FIG. 2 further including a stator assembly.

FIG. 4 illustrates the radial flux motor assembly of FIG. 1 further including the stator assembly.

FIG. 5 illustrates a cross-sectional view of the radial flux motor assembly of FIG. 4, further illustrating electromagnets of the stator assembly and permanent magnets of the rotor assembly.

FIG. 6a illustrates the sensor assembly of the radial flux motor assembly of FIG. 1.

FIG. 6b illustrates magnetic flux shielding extending from the sensor assembly of FIG. 6a.

FIG. 7 illustrates the radial flux motor assembly of FIG. 1 with the rotor assembly and the motor shaft removed to better illustrate the first portion of the motor housing and the sensor assembly.

FIG. 8 illustrates another view of the radial flux motor assembly of FIG. 1.

FIG. 9 illustrates another view of the radial flux motor assembly of FIG. 7.

FIG. 10 illustrates a second portion of the motor housing of the radial flux motor assembly of FIG. 1 assembled with the motor shaft, the rotor assembly, and the stator assembly.

FIG. 11 illustrates a method of operating the radial flux motor assembly of FIG. 1.

FIG. 12. illustrates the sinusoidal variation of radial and axial components of a BLDC or PMAC rotor magnetic flux relative to the angular position of a motor shaft.

FIG. 13 illustrates a method for determining the angular position of a motor shaft of a radial flux motor.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

Disclosed herein is a way to eliminate the need for sense magnets or a sense magnet rotor by utilizing axial leakage fluxes of the existing permanent magnet primary rotor. The elimination of the sense magnets or the sense magnet rotor reduces both the weight and the length of the electric motor. A radial flux motor assembly has a motor housing enclosing a rotor assembly mounted on a motor shaft and a stator assembly mounted radially outward of the rotor assembly. The rotor assembly includes a plurality of permanent magnets having a first magnetic flux. The stator assembly includes a multiplicity of windings disposed on a stator core to define an electromagnet having a second magnetic flux when the windings are energized. The angular position of the motor shaft can be determined at any time during operation of the motor using a sensor assembly mounted along the motor shaft and spaced axially apart from the rotor assembly and radially inward of the stator assembly. The sensor assembly includes at least one hall effect sensor which is fixed relative to the housing to be within the first magnetic flux and substantially outside of the second magnetic flux in order to detect a first magnetic flux axial component propagating parallel to the motor shaft.

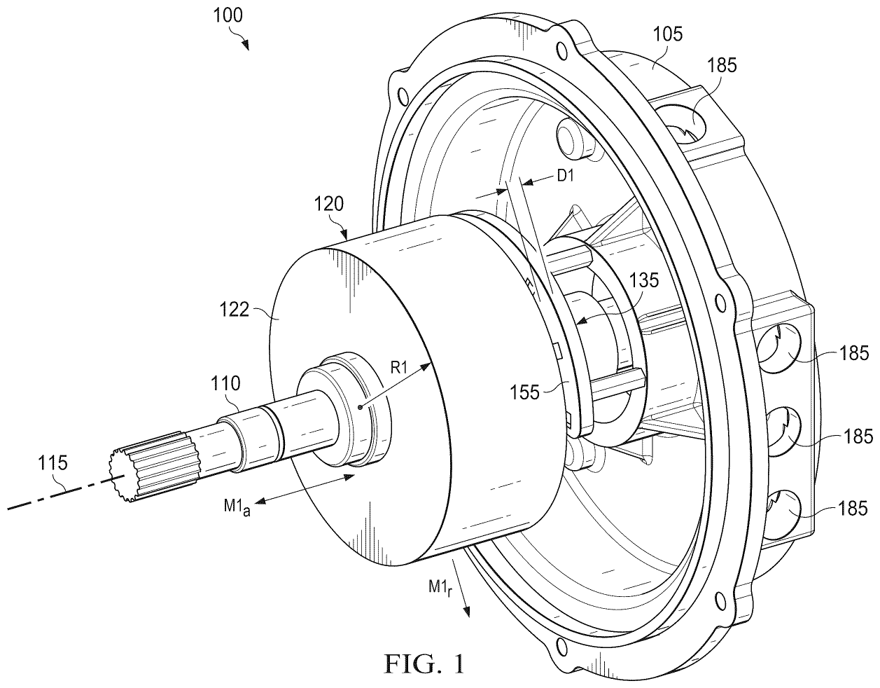

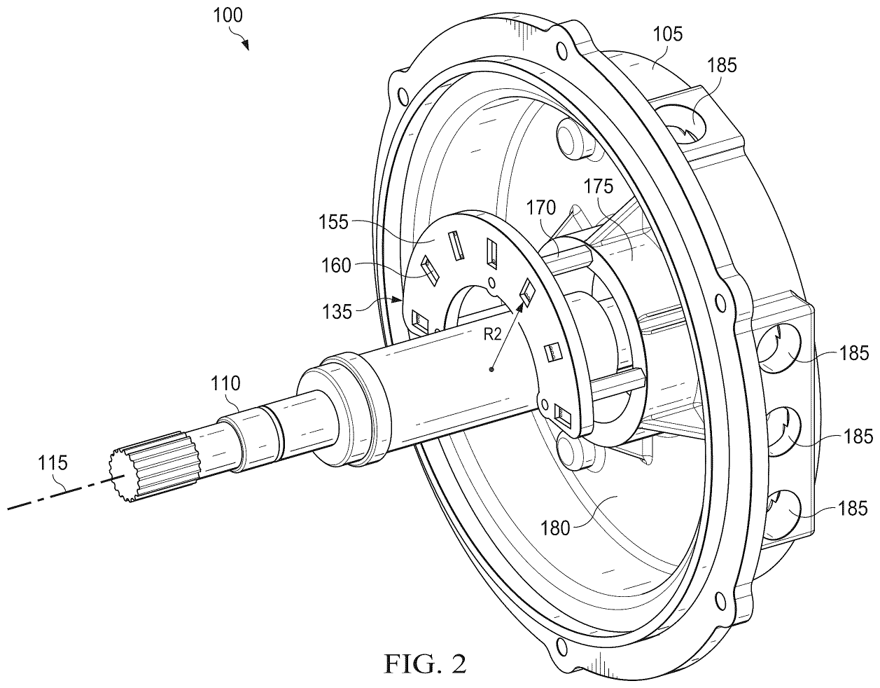

Referring to FIGS. 1 and 2, a radial flux motor assembly 100 is shown and described. The radial flux motor assembly 100 includes a motor housing 105 with a motor shaft 110 extending along a motor axis 115 that extends axially through the motor housing 105. In one or more embodiments, the radial flux motor assembly 100 may be either a brushless DC electric motor (“BLDC”) or permanent magnet AC motor (“PMAC”). The motor housing 105 includes a primary rotor assembly 120 mounted on the motor shaft 110 and coaxially aligned with the motor axis 115.

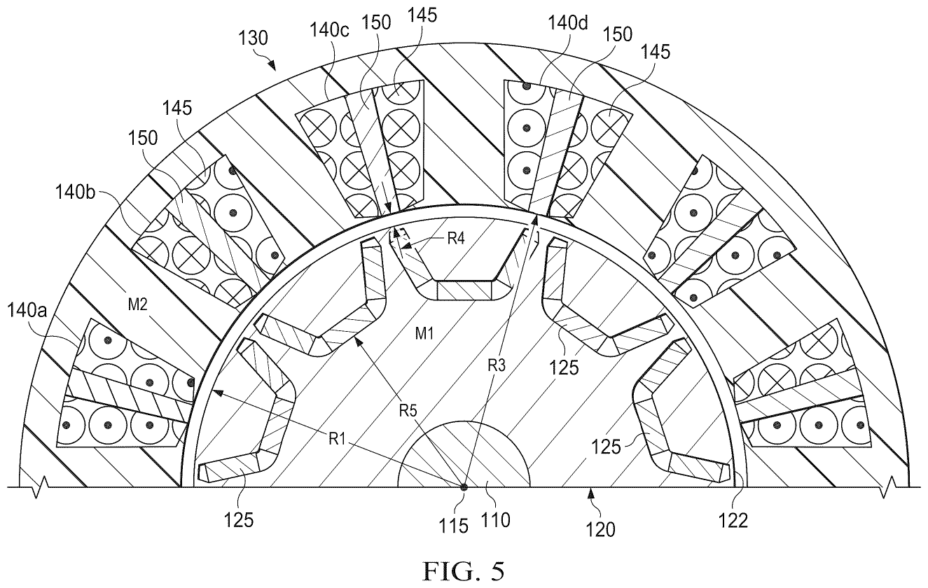

The primary rotor assembly 120 extends circumferentially about the motor shaft 110 and the motor axis 115 through 360 degrees. The primary rotor assembly 120 includes a rotor housing 122. In one or more embodiments, the rotor housing 122 has a radially outer surface that is spaced apart from the motor axis 115 a distance R1 representing the outer radius of the rotor housing 122. As shown in FIG. 1, the primary rotor assembly 120 produces a first magnetic flux M1 with an axial magnetic flux component M1ₐ and a radial magnetic flux component M1ᵣ, where the axial magnetic flux component M1ₐ of first magnetic flux M1 is generally parallel to the motor axis 115 and the radial magnetic flux component M1ᵣ of first magnetic flux M1 is generally perpendicular to the motor axis 115. The first magnetic flux M1 is produced by first magnets 125 (see FIG. 5) of the primary rotor assembly 120.

A sensor assembly 135 is also disposed along motor axis 115. The sensor assembly 135 is mounted to the motor housing 105 such that sensor assembly 135 is fixed relative to the motor housing 105. The sensor assembly 135 is positioned along, and is radially spaced apart from, the motor shaft 110 such that the motor shaft 110 is able to rotate relative to the sensor assembly 135. The sensor assembly 135 is also axially spaced apart from the primary rotor assembly 120 along the motor shaft 110 such that the primary rotor assembly 120 is able to rotate relative to the sensor assembly 135. The primary rotor assembly 120 and the sensor assembly 135 are positioned within and enclosed by the motor housing 105. The sensor assembly 135 is fixed relative to the motor housing 105 to be within at least a portion of the axial magnetic flux component M1ₐ of first magnetic flux M1 of the primary rotor assembly 120. In this regard, the sensor assembly 135 is spaced apart an axial distance D1 which defines the axial spacing between the sensor assembly 135 and the primary rotor assembly 120.

As best seen in FIG. 2 where the primary rotor assembly 120 of FIG. 1 is removed to better illustrate sensor assembly 135, sensor assembly 135 includes a mount 155 and at least one magnetic flux sensor 160 mounted or attached to the mount 155 such that the at least one magnetic flux sensor 160 is positioned to detect at least a portion of the axial magnetic flux component M1ₐ of first magnetic flux M1 of the primary rotor assembly 120. In one or more embodiments, measurement of the axial magnetic flux component M1ₐ of first magnetic flux M1 can be improved by including two or more magnetic flux sensors 160. In any event, in one or more embodiments, the at least one magnetic flux sensor 160 is positioned to detect primarily the axial leakage fluxes of the axial magnetic flux component M1ₐ of first magnetic flux M1 of primary rotor assembly 120 without substantial detection or interference of other magnetic flux, such as magnetic flux M2. In the embodiment shown, the at least one magnetic flux sensor 160 is a Hall effect sensor adapted to detect at least a portion of the axial magnetic flux component M1ₐ of first magnetic flux M1. In one or more embodiments, the sensor assembly 135 may further include at least one temperature sensor 165 adapted to measure and monitor the temperature of the sensor assembly 135, the primary rotor assembly 120, or the interior area defined within the motor housing 105. In one or more embodiments, the mount 155 may be a printed circuit board.

In one or more embodiments, the at least one magnetic flux sensor 160 or the at least one temperature sensor 165 may be mechanically and electrically attached to the mount 155. In one or more embodiments, the at least one sensor 160 or the at least one temperature sensor 165 may be attached to the mount 155 via terminal connections, snap fit or press fit connections, tolerance fit connections, fasteners, soldering, or other means known in the art.

In any event, mount 155 is radially spaced apart from the motor shaft 110 and extends circumferentially about at least a portion of the motor axis 115 and the motor shaft 110. In one or more embodiments, the mount 155 extends circumferentially about the motor axis 115 and the motor shaft 110 through at least 90 degrees. In one or more embodiments, the mount 155 extends circumferentially about the motor axis 115 and the motor shaft 110 through at least 180 degrees. In one or more embodiments, the mount 155 extends circumferentially about the motor axis 115 and the motor shaft 110 through at least 270 degrees. In one or more embodiments, the mount 155 extends circumferentially about the motor axis 115 and the motor shaft 110 a full 360 degrees. In one or more embodiments, the mount 155 extends circumferentially about the motor axis 115 and the motor shaft 110 between 0 degrees and 90 degrees. In one or more embodiments, the mount 155 extends circumferentially about the motor axis 115 and the motor shaft 110 between 90 degrees and 180 degrees. In one or more embodiments, the mount 155 extends circumferentially about the motor axis 115 and the motor shaft 110 between 180 degrees and 270 degrees. In one or more embodiments, the mount 155 extends circumferentially about the motor axis 115 and the motor shaft 110 between 270 degrees and 360 degrees.

When attached to the mount 155, the at least one sensor 160 is positioned along, and radially spaced apart from, the motor axis 115 and the motor shaft 110. In the embodiment shown, the at least one sensor 160 is radially spaced apart from the motor axis 115 a distance R2. While sensors 160 are all shown as being spaced the same distance R2, it will be appreciated in other embodiments, individual sensors 160 may have different radial distances R2.

The mount 155 of the sensor assembly 135 is attached to the motor housing 105 via one or more supports 170 (or “standoffs”) that support the sensor assembly 135 at a desired position relative to the primary rotor assembly 120 namely, within the axial magnetic flux component M1ₐ of first magnetic flux M1. In one or more embodiments, the sensor assembly 135 may include the one or more supports 170. In one or more embodiments, the supports 170 may be brass studs. In one or more embodiments, the one or more supports 170 may be integrally formed with the mount 155 or the motor housing 105. In one or more other embodiments, the one or more supports 170 may be attached to the mount 155 or to the motor housing 105 via fasteners, welding, soldering, adhesive, snap fit, or any other means as would be readily apparent to one of ordinary skill in the art and as required by the application. In still other embodiments, the one or more supports 170 may be semi-permanently mounted to the motor housing 105 such that the one or more supports 170 may be adjusted in order to adjust the axial position or the radial position of the sensor assembly 135 relative to the primary rotor assembly 120.

In one or more embodiments, the one or more supports 170 may extend from a hub 175 that is integrally formed with, or welded to, the motor housing 105. In one or more embodiments, the hub 175 may extend from an interior surface 180 of the motor housing 105. In one or more other embodiments, the one or more supports 170 may extend directly from, or be mounted through, the interior surface 180 of the motor housing 105. In some embodiments where the hub 175 is present, the one or more supports 170 may extend from the interior surface 180 of the motor housing 105 radially outward of the hub 175.

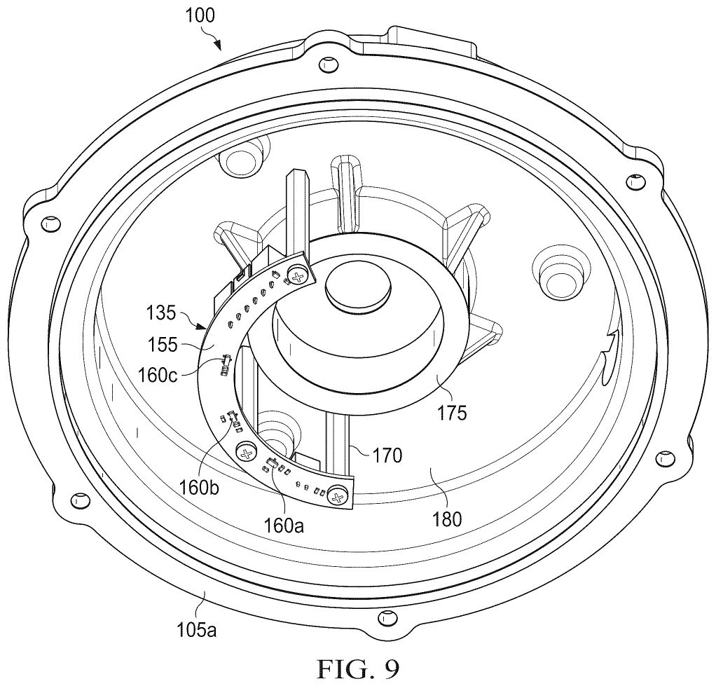

Motor housing 105 may also include one or more openings 185 (or “bores”) for electrical wiring 195 (sec FIG. 10).

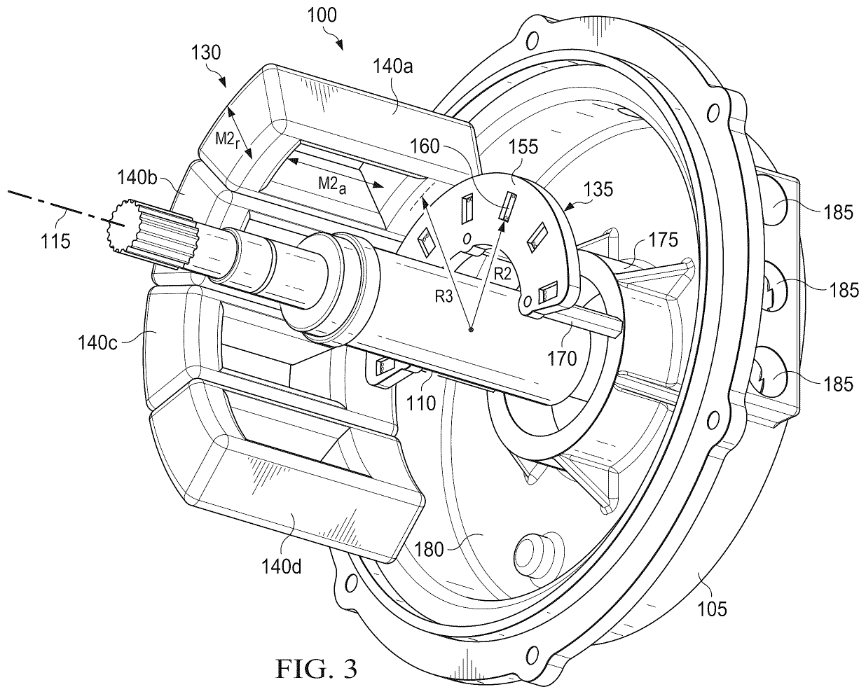

FIG. 3 is similar to FIG. 2, but includes a stator assembly 130 and illustrates positioning of stator assembly 130 relative to sensor assembly 135. The stator assembly 130 is mounted radially outward of motor axis 115 and is enclosed by and fixed relative to the motor housing 105. The stator assembly 130 includes one or more second magnets 140 spaced radially outward from the motor axis 115 at a distance R3. In the illustrated embodiment, a plurality of second magnets 140a, 140b, 140c, and 140d are illustrated. In or more embodiments, the second magnets 140 are electromagnets. In the embodiment shown, the distance R3 is measured from the motor axis 115 to the radially innermost point of the one or more second magnets 140. Thus, the distance R3 is greater than the distance R1. In one or more embodiments, the distance R3 is also greater than the distance R2. The stator assembly 130 has a second magnetic flux M2 created by, or resulting from, the one or more second magnets 140. Second magnetic flux M2 can be characterized as having an axial magnetic flux component M2a and a radial magnetic flux component M2r, where the axial magnetic flux component M2a of second magnetic flux M2 is generally parallel to the motor axis 115 and the radial magnetic flux component M2r of second magnetic flux M2 is generally perpendicular to the motor axis 115.

With respect to the stator assembly 130, where the one or more second magnets 140 are electromagnets, each second magnet 140 may be formed of one or more coils of wire windings 145 wound around one or more stator cores or yokes or teeth 150 (see FIG. 5). In the illustrated embodiment, a plurality of second magnets 140 are shown. In one or more embodiments, the wire of the wire windings 145 is an insulated copper wire. In one or more embodiments, the one or more cores 150 are magnetic and may be made of ferromagnetic or ferrimagnetic material such as iron, steel, nickel, or cobalt. In one or more embodiments, the radial flux motor assembly 100 is a 3-phase electric motor and includes three sets of wire windings 145 corresponding to the three stator phases of the 3-phase electric motor. In any event, the second magnetic flux M2 arising from stator assembly 130 is created by, or otherwise results from, the one or more electromagnets 140.

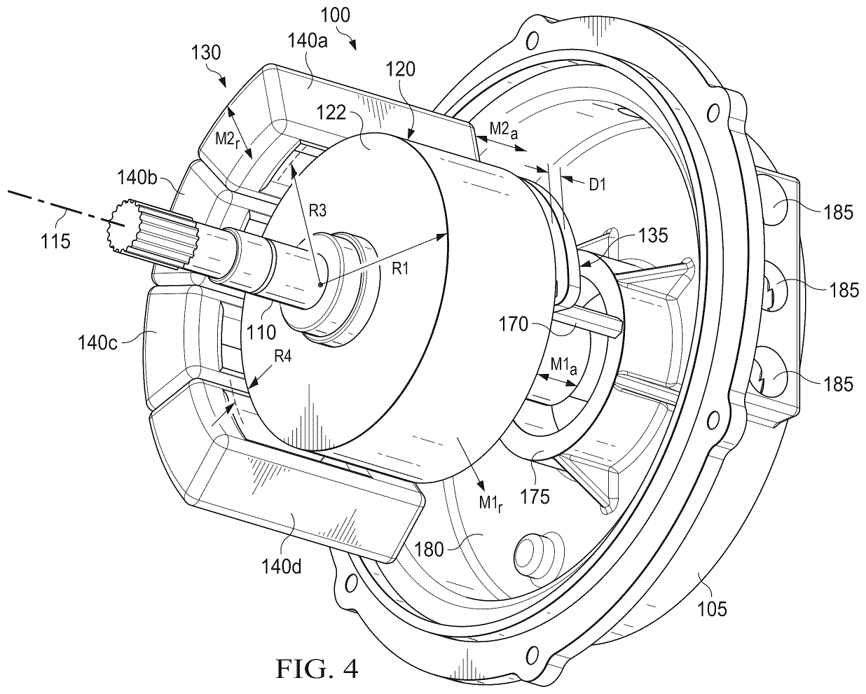

FIG. 4 is similar to FIG. 3 but includes rotor assembly 120 and illustrates the relationships between the rotor assembly 120, the stator assembly 130, the sensor assembly 135. As shown, the stator assembly 130 is mounted radially outward of the primary rotor assembly 120. In particular, the stator assembly 130 is radially spaced apart from the primary rotor assembly 120 a distance R4 about the entire circumference of the primary rotor assembly 120 such that the primary rotor assembly 120 is able to rotate relative to the stator assembly 130 without any frictional resistance that would result from contact with the stator assembly 130. In one or more embodiments, the distance R4 is equal to the distance R3 less the distance R1. Most importantly, it will be appreciated that the positioning of sensor assembly 135, and specifically, sensors 160, along motor axis 115 is selected to be within the first magnetic flux M1 and substantially outside of the second magnetic flux M2. In particular, sensors 160 are positioned to be substantially within the axial magnetic flux component M1ₐ of first magnetic flux M1 and outside the axial magnetic flux component M2ₐ of second magnetic flux M2.

The sensor assembly 135 is mounted to the motor housing 105 such that sensor assembly 135 is fixed relative to the motor housing 105. The sensor assembly 135 is positioned along, and is radially spaced apart from, the motor shaft 110 such that the motor shaft 110 is able to rotate relative to the sensor assembly 135. The sensor assembly 135 is also axially spaced apart from the primary rotor assembly 120 and the stator assembly 130 along the motor shaft 110 such that the primary rotor assembly 120 is able to rotate relative to the sensor assembly 135. In one or more embodiments, the sensor assembly 135 is radially spaced apart from the stator assembly 130. In one or more embodiments, each of the primary rotor assembly 120, the stator assembly 130, and the sensor assembly 135 is positioned within and enclosed by the motor housing 105.

More specifically, the sensor assembly 135 is fixed relative to the motor housing 105 to be within at least a portion of the first magnetic flux M1 of the primary rotor assembly 120 and substantially outside of the second magnetic flux M2 of the stator assembly 130. In one or more embodiments, the sensor assembly 135 is within axial leakage flux component M1ₐ of the first magnetic flux M1 and is substantially outside of radial flux component M1ᵣ of the first magnetic flux M1. In one or more embodiments, the sensor assembly is substantially outside of both axial leakage flux component M2ₐ and radial flux component M2ᵣ of the second magnetic flux M2. As used herein, axial “leakage” fluxes refer to magnetic fluxes that are detectable axially along the motor shaft 110, as opposed to radially outward from the primary rotor assembly 120 or radially inward from the stator assembly 130. In such embodiments, the sensor assembly 135 is able to detect the axial leakage flux component M1ₐ of the first magnetic flux M1 without disruption or interference from the radial flux component M1ᵣ of the first magnetic flux M1 or from the axial leakage flux component M2ₐ or the radial flux component M2ᵣ of the second magnetic flux M2.

In one or more embodiments, the distance R2 (see FIGS. 2 and 3) is less than the distance R3. In one or more embodiments, the distance R2 is less than or equal to the distance R1. In one or more embodiments, the distance R2 is greater than the radial height of the radially innermost edge portion of the primary rotor assembly 120 and is less than the distance R1 such that at least a portion of the at least one sensor 160 is positioned radially within the radial extension of the primary rotor assembly 120. In one or more embodiments, the distance R2 is sized such that the at least one sensor 160 is radially spaced apart from the stator assembly 130. In any event, it will be appreciated that the axial and radial positions of the sensors 160 are selected so as to maximize detection of M1 and minimize detection of M2.

It will be appreciated that it is desirable to select an axial distance D1 defining the axial spacing between the sensor assembly 135 and the primary rotor assembly 120 so that the at least a portion of the first magnetic flux M1 of the primary rotor assembly 120 can be utilized to determine the angular position of the primary rotor assembly 120 without undue interference from the second magnetic flux M2 of the stator assembly 130. Thus, the axial distance D1 may depend in part on the strength of the axial leakage flux component M1ₐ, M2ₐ of the first magnetic flux M1 or the second magnetic flux M2 and may be optimized to minimize the impact of the second magnetic flux M2 on the sensor assembly 135. In other words, the sensor assembly 135, including the mount 155 and the at least one sensor 160, is positioned such that the axial leakage flux component M2ₐ of the second magnetic flux M2 of the stator assembly 130 do not interfere with the measurement of the axial leakage flux component M1ₐ of the first magnetic flux M1 of the primary rotor assembly 120 by the sensor assembly 135.

When properly positioned, the at least one sensor 160 detects only the axial leakage flux component M1ₐ of the first magnetic flux M1 of the primary rotor assembly 120. In one or more embodiments, it may be necessary to select the distance D1 such that the sensor assembly 135 is fully outside of the axial leakage flux component M2ₐ of the second magnetic flux M2 of the stator assembly 130. In one or more other embodiments, the distance D1 may be selected such that the sensor assembly 135 is positioned within the axial leakage flux component M2ₐ of the second magnetic flux M2, but such that the impact of the axial leakage flux component M2ₐ of the second magnetic flux M2 on the determination of the angular position of the primary rotor assembly 120 by the sensor assembly 135 is limited. In one or more embodiments, the axial distance D1 between the sensor assembly 135 and the primary rotor assembly 120 may be 1-5 millimeters. In one or more other embodiments, the distance D1 may be approximately 10 millimeters or less. In one or more other embodiments, the axial distance D1 is between approximately 5 and 15 millimeters in order to maximize detection of axial magnetic flux component M1ₐ of first magnetic flux M1 while minimizing any detection or impact of axial magnetic flux component M2ₐ of second magnetic flux M2 on the measured axial flux value.

In one or more embodiments, the axial lengths of the primary rotor assembly 120 and of the stator assembly 130 may be equal such that axially opposing surfaces of the primary rotor assembly 120 are coplanar with respective axially opposing surfaces of the stator assembly 130. In such embodiments, the distance D1 would also be the axial spacing between the sensor assembly 135 and the stator assembly 130.

FIG. 5 is a cross-section of the rotor assembly 120 and the stator assembly 130 to illustrate their relationship to one another. Rotor assembly 120 includes one or more first magnets 125 supported by the rotor housing 122 and radially spaced apart from the motor axis 115 a distance R5. In one or more embodiments, the first magnets 125 are permanent magnets. It will be appreciated that permanent magnets may be desirable because they produce a constant magnetic flux, in contrast to electromagnets where the magnetic flux may vary. In the illustrated embodiment, a plurality of first magnets 125 are shown. In one or more embodiments, the first magnets 125 may be V-shaped permanent magnets. In one or more other embodiments, the first magnets 125 may be U-shaped permanent magnets. It will be appreciated that the disclosure is not limited to a particular number or arrangement of first magnets 125. In the embodiment shown, the distance R5 is measured from the motor axis 115 to the radially innermost point of the one or more first magnets 125. The one or more first magnets 125 may be equally distributed circumferentially about the primary rotor assembly 120 at the distance R5. In any event, the first magnetic flux M1 arising from primary rotor assembly 120 is created by, or otherwise results from, the one or more first magnets 125.

With respect to the stator assembly 130, where the one or more second magnets 140 are electromagnets, each second magnet 140 may be formed of one or more coils of wire windings 145 wound around one or more stator cores or yokes or teeth 150. In the illustrated embodiment, a plurality of second magnets 140a, 140b, 140c, 140d are shown. In one or more embodiments, the wire of the wire windings 145 is an insulated copper wire. In one or more embodiments, the one or more cores 150 may be made of ferromagnetic or ferrimagnetic material such as iron, steel, nickel, or cobalt. In one or more embodiments, the radial flux motor assembly 100 is a 3-phase electric motor and includes three sets of wire windings 145 corresponding to the three stator phases of the 3-phase electric motor. In any event, the second magnetic flux M2 arising from stator assembly 130 is created by, or otherwise results from, the one or more electromagnets 140.

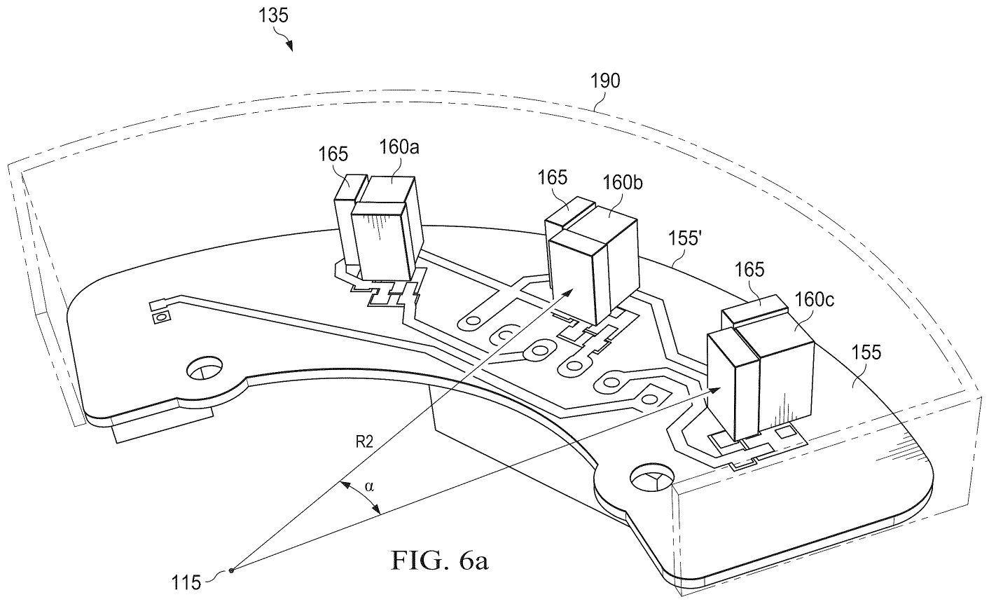

With reference to FIG. 6a, in one or more embodiments, the sensor assembly 135 includes at least two sensors 160a, 160b circumferentially spaced apart from each other about the motor axis 115 and along the mount 155. In one or more other embodiments, the sensor assembly 135 includes at least three sensors 160a, 160b, 160c circumferentially spaced apart from each other about the motor axis 115 and along the mount 155. The mount 155 may fix the spacing between adjacent sensors 160a, 160b, 160c. While one sensor 160 may be utilized to measure the magnetic leakages as described herein, two or more sensors 160 are preferable in order to better determine the angular position of the primary rotor assembly 120. In this regard, three or more sensors 160 may be utilized to triangulate the angular position of the primary rotor assembly 120.

While the angular spacing α between adjacent sensors need not be uniform or of any particular angle, in one or more embodiments, the fixed angular spacing α between adjacent sensors 160 may be sixty electrical degrees. In one or more embodiments, the fixed spacing α between adjacent sensors 160 may be one hundred twenty electrical degrees. In one or more other embodiments, the sensor assembly 135 may have other angular spacing a between adjacent sensors 160. In one or more embodiments, the angular spacing α between adjacent sensors 160 is equal. In one or more embodiments, a plurality of spaced apart sensors 160 are symmetrically positioned on mount 155 about motor axis 115.

In one or more embodiments, the sensor(s) 160 are Hall effect sensors and at least one temperature sensor 165. In one or more embodiments, where present, the at least one temperature sensor 165 may be positioned at any desired location on the mount 155 where the at least one temperature sensor 165 will not interfere with the operation of the at least one sensor 160.

Although not limited to a particular power source, in one or more other embodiments, power may be supplied to the at least one sensor 160 and/or the at least one temperature sensor 165 via a wired connection, such as a power supply wire and a ground wire extending through one or more openings 185 (or “bores”) in the motor housing 105 (see FIG. 1). In one or more embodiments, power may be supplied to the mount 155 and transferred to the sensors via electrically conductive material associated with the mount 155.

In one or more embodiments, to further minimize the impact of the axial magnetic flux component M2ₐ of second magnetic flux M2 on the measured axial magnetic flux component M1ₐ of first magnetic flux M1 by the sensor assembly 135, the radial flux motor assembly 100 may further include magnetic flux shielding 190 positioned circumferentially about the motor axis 115 and the motor shaft 110. In such embodiments, the magnetic flux shielding 190 is radially spaced apart from the primary rotor assembly 120 and radially outward of the sensors 160 such that the magnetic flux shielding 190 does not interfere with or prevent the axial leakage flux component M2ₐ of the second magnetic flux M2 from being detected by the sensor assembly 135. As used herein, shielding 190 refers to any structure or material that can reduce passage of magnetic flux M2 therethrough or redirect a magnetic field to minimize the effects of the redirected magnetic field M2 on sensors 160. In one or more embodiments, shielding 190 may be an iron sleeve. In one or more embodiments, shielding 190 may be formed of any material with a magnetic permeability greater than 1, including but not limited to iron, transformer steel, and mumetal. In one or more embodiments, shielding 190 may be formed of any material a high magnetic permeability, including without limitation, nickel and cobalt alloys.

In one or more embodiments, the magnetic flux shielding 190 may be axially spaced apart from the primary rotor assembly 120. In one or more embodiments, the magnetic flux shielding 190 may be positioned radially outward of the sensor assembly 135. In the illustrated embodiment, the magnetic flux shielding 190 extends from adjacent the outer edge 155′ of the mount 155 to at least the outer diameter of the stator assembly 130. In this regard, the magnetic flux shielding may be supported by or extend outward from the mount 155 or may be supported by motor housing 105. The magnetic flux shielding 190 may circumferentially extend only partially around motor axis 115 so that the magnetic flux shielding 190 is positioned only adjacent sensor assembly 135 or magnetic flux shielding 190 may circumferentially extend around a greater portion of the circumference, either partially or fully around, motor axis 115 in order to enhance shielding of sensor(s) 160 from any axial migration of the second magnetic flux M2. Thus, in some embodiments, shielding 190 may be a sleeve that has a radius Rₛ that is greater than the radius R₂ and less than the radius R₃. In one or more embodiments, the magnetic flux shielding 190 may extend from at least the inner edge to the outer edge of stator assembly 130. In each of the disclosed embodiments, the magnetic flux shielding 190 is adapted to reduce the incidence of axial leakage flux component M2ₐ from the second magnetic flux M2 of the stator assembly 130 reaching the sensor(s) 160 and interfering with angular position data generated by the at least sensor(s) 160.

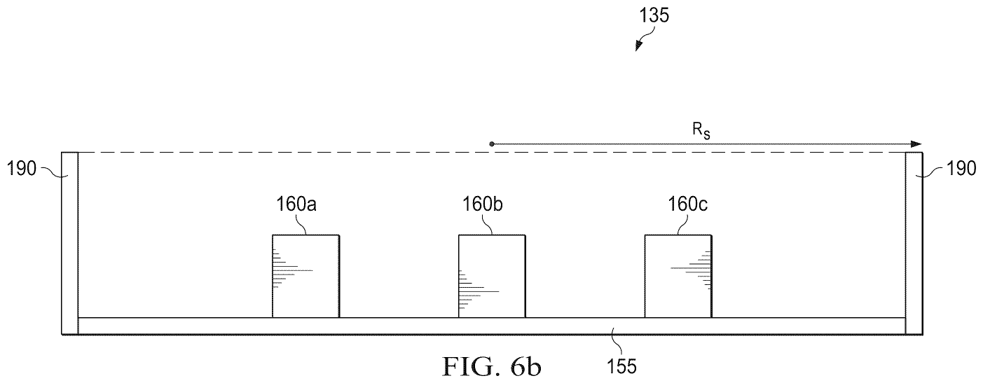

FIG. 7 illustrates an additional view of the motor housing 105 and the sensor assembly 135 of the radial flux motor assembly 100. It will be appreciated that the length of mounts 170 may be adjusted to achieve the desired axial distance D1 between the primary rotor assembly 120 and the sensor assembly 135 as described above.

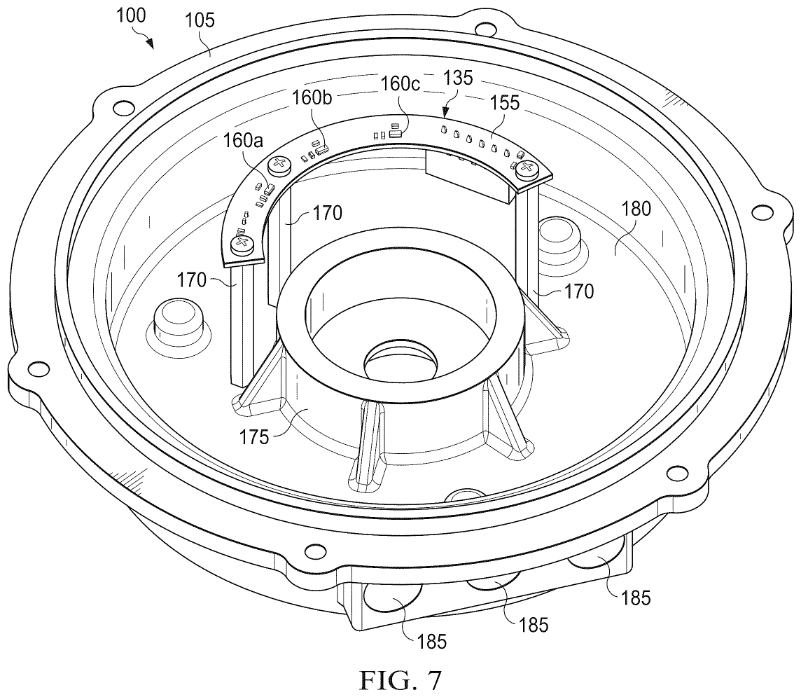

FIG. 8 illustrates an additional view of the radial flux motor assembly 100. Motor assembly 100 includes a motor housing 105, which is illustrated with a motor shaft 110 extending through motor housing 105. The motor housing 105 is utilized to encase primary rotor assembly 120 mounted on the motor shaft 110. The primary rotor assembly 120 includes a rotor housing 122 disposed about one or more first magnets 125 (shown in dashed). In one or more embodiments, the one or more first magnets 125 are permanent magnets and produce a constant magnetic flux. In any event the first magnets 125 of primary rotor assembly 120 produce a first magnetic flux M1 with an axial magnetic flux component M1ₐ and a radial magnetic flux component M1ᵣ, where the axial magnetic flux component M1ₐ of first magnetic flux M1 is generally parallel to the motor shaft 110 and the radial magnetic flux component M1ᵣ of first magnetic flux M1 is generally perpendicular to the motor shaft 110.

A sensor assembly 135 is also disposed about motor shaft 110. The sensor assembly 135 is mounted to the motor housing 105 such that sensor assembly 135 is fixed relative to the motor housing 105. The sensor assembly 135 is positioned along, and is radially spaced apart from, the motor shaft 110 such that the motor shaft 110 is able to rotate relative to the sensor assembly 135. The sensor assembly 135 is also axially spaced apart from the primary rotor assembly 120 along the motor shaft 110 such that the primary rotor assembly 120 is able to rotate relative to the sensor assembly 135. The axial position of sensor assembly 135 along motor shaft 110 is selected so that at least a portion of the axial magnetic flux component M1ₐ of first magnetic flux M1 of the primary rotor assembly 120 is detectable by sensor assembly 135.

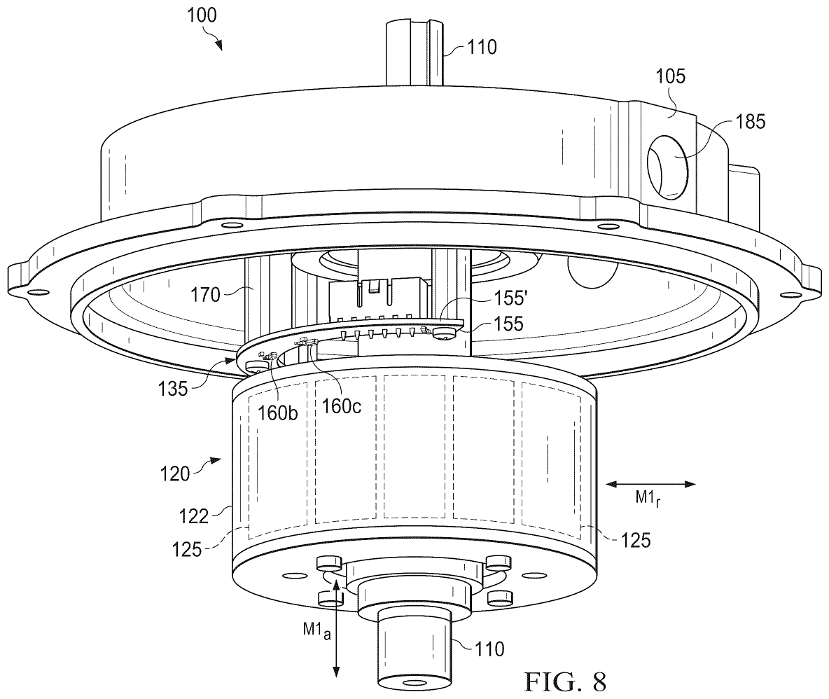

With reference to FIGS. 9 and 10, it will be appreciated that the motor housing 105 of radial flux motor assembly 100 is formed of a first housing portion 105a and second housing portion 105b, prior to being fully assembled. In the embodiment shown, first housing portion 105a includes the sensor assembly 135 mounted within the first housing portion 105a of the motor housing 105 and the second housing portion 105b includes the stator assembly 130 mounted within the second housing portion 105b of the motor housing 105. Phase wires 195, shown in FIG. 10, extend from the coils of wire windings 145 (see FIG. 5) of the one or more electromagnets 140. In the illustrated embodiment, radial flux motor assembly 100 is three phase and thus phase wires 195a, 195b, and 195c representing different phrases are shown. The phase wires 195 are electrically coupled with the coils of wire windings 145 to provide power to the one or more second magnets 140. In one or more embodiments, when the motor housing 105 is fully assembled, the phase wires 195 may extend through the one or more openings 185 in the motor housing, which may be positioned in the first housing portion 105a of the motor housing 105. In one or more embodiments, the one or more opening 185 may be positioned in the second housing portion of the motor housing 105b.

In one or more embodiments, the radial flux motor assembly 100 is further assembled by mounting the primary rotor assembly 120 onto the motor shaft 110. At least a portion of the primary rotor assembly 120 and at least a portion of the motor shaft 110 are then received within the second housing portion 105b of the motor housing 105 such that the primary rotor assembly 120 is circumferentially bounded by the stator assembly 130. The first housing portion 105a of the motor housing 105 is then positioned onto a portion of the motor shaft 110 extending from the second housing portion 105b of the motor housing 105 such that the first housing portion 105a and the second housing portion 105b of the motor housing 105 can be joined together to enclose the primary rotor assembly 120, the stator assembly 130 and the sensor assembly 135. As the motor housing 105 is assembled, the sensor assembly 135 is brought into spatial relation with the primary rotor assembly 120 and the stator assembly 130 as described above. One or more bearings 196 may be positioned on motor shaft 110 between the first housing portion 105a or the second housing portion 105b of the motor housing 105 and the motor shaft 110 to support motor shaft 110 and facilitate relative rotation between the motor shaft 110 and the motor housing 105.

In FIG. 9, sensor assembly 135 is shown supported on standoffs 170 which are fixed to the interior surface 180 of first motor housing portion 105a and extend from adjacent hub 175. Sensor assembly 135 is shown having a mount 155 on which are attached a plurality of sensors 160a, 160b, 160c as generally described above.

Although not required, in one or more embodiments, as shown in FIG. 10, motor housing 105 may include a plurality of cooling fins 198 extending outward from an exterior surface 105b′ of second housing portion 105b. Cooling fins 198 dissipate heat from the radial flux motor assembly 100. In one or more embodiments, either first housing portion 105a, second housing portion 105b, or both may include cooling fins 198.

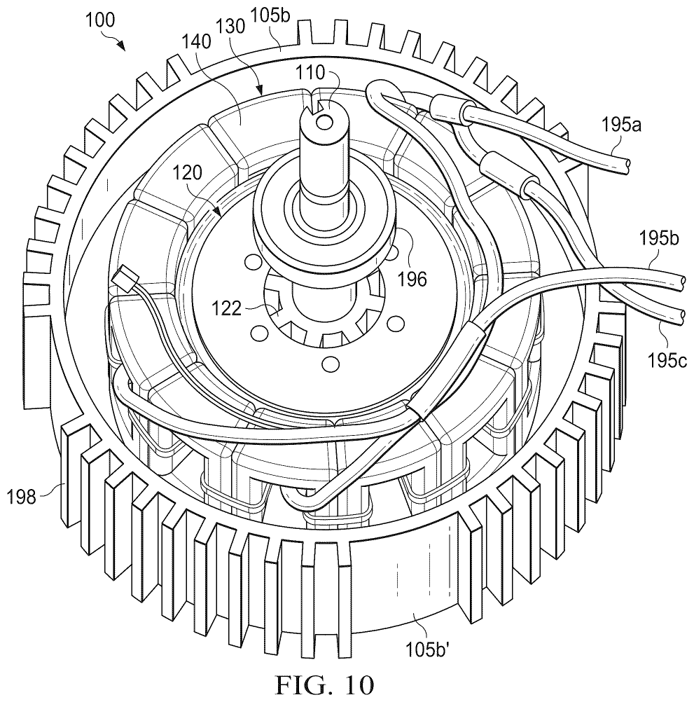

Referring to FIG. 11, a method 1100 of operating the radial flux motor assembly 100 is shown and described. The method 1100 includes positioning a rotor assembly having a first magnetic flux M1 within a stator assembly; energizing the coils of the stator assembly to produce a second magnetic flux M2; positioning a Hall effect sensor along a motor axis extending axially through the rotor assembly and stator assembly; utilizing the Hall effect sensor to measure an axial magnetic flux component of the magnetic flux produced by the rotor assembly; and adjusting the position of the Hall effect sensor axially along the motor axis to maximize the measured axial magnetic flux component of the magnetic flux produced by the rotor assembly. In one or more embodiments, while the axial adjustment may be selected to ensure that axial magnetic flux component of the magnetic flux produced by the stator assembly has a value that is less than the value of the axial magnetic flux component of the magnetic flux produced by the rotor assembly. In one or more embodiments, the method 1100 further includes adjusting the position of the Hall effect sensor axially along the motor axis until the second axial flux value is substantially zero.

With continued reference to FIG. 11, at step 1105, a rotor assembly comprising a plurality of permanent magnets that produce a first magnetic flux of the rotor assembly is positioned within a stator assembly comprising a plurality of electromagnets. At step 1110, the plurality of electromagnets of the stator assembly are energized to produce a second magnetic flux of the stator assembly. At step 1115, a Hall effect sensor is positioned along a motor axis extending axially through the rotor assembly and the stator assembly. At step 1120, a first magnetic flux value associated with the first magnetic flux and a second magnetic flux value associated with the second magnetic flux are measured using the Hall effect sensor. At step 1125, the position of the Hall effect sensor axially along the motor axis is adjusted until the second axial flux value is zero. And at step 1135, an angular position of the rotor assembly is determined based on the first axial magnetic flux M1, and in particular, axial magnetic flux component M1ₐ of first magnetic flux M1.

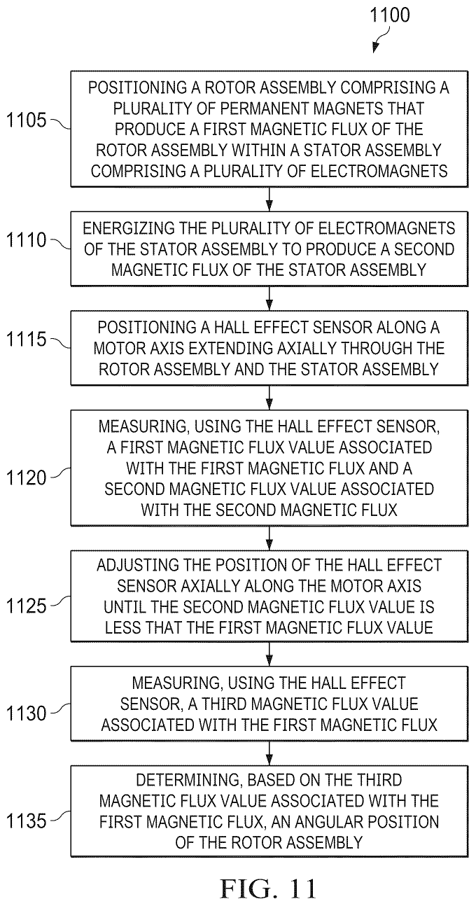

With reference to FIG. 12, in determining the angular position of a motor shaft of a radial flux motor 100 as described herein, it should be noted that first magnetic flux M1 is the primary magnetic flux for radial motor assembly 100. The radial magnetic flux component M1ᵣ of first magnetic flux M1 is primarily responsible for torque production of radial motor assembly 100, although radial magnetic flux component M2ᵣ of second magnetic flux M2 may also contribute to torque production. In this regard, axial magnetic flux component M1ₐ of first magnetic flux M1 does not contribute to the torque production of motor assembly 100 but is utilized for the sensing of the rotor assembly and motor shaft position.

Notably, radial magnetic flux component M1ᵣ has a larger sinusoidal flux density amplitude than the axial magnetic flux component M1ₐ. However, while the axial magnetic flux component M1ₐ of first magnetic flux M1 has a smaller sinusoidal flux density than amplitude radial magnetic flux component M1ᵣ, axial magnetic flux component M1ₐ is still large enough to be detected by the sensor assembly 135. Moreover, it has been observed that while the magnetic flux amplitudes of axial magnetic flux component M1ₐ and radial magnetic flux component M1ᵣ differ, the magnetic flux components M1ₐ and M1ᵣ are electrically in phase along the sinusoidal curve representing first magnetic flux M1. In this regard, in one or more embodiments, were first magnetic flux M1 is produced by permanent magnets, the sinusoidal flux density amplitude of first magnetic flux M1, and the corresponding component amplitudes, is uniform during operation of radial motor assembly 100. In contrast, depending on the operating point (level of the injected stator phase currents) of radial motor assembly 100, the sinusoidal flux density amplitude of second magnetic flux M2 varies. It might be much smaller than first magnetic flux M1, or comparable to first magnetic flux M1.

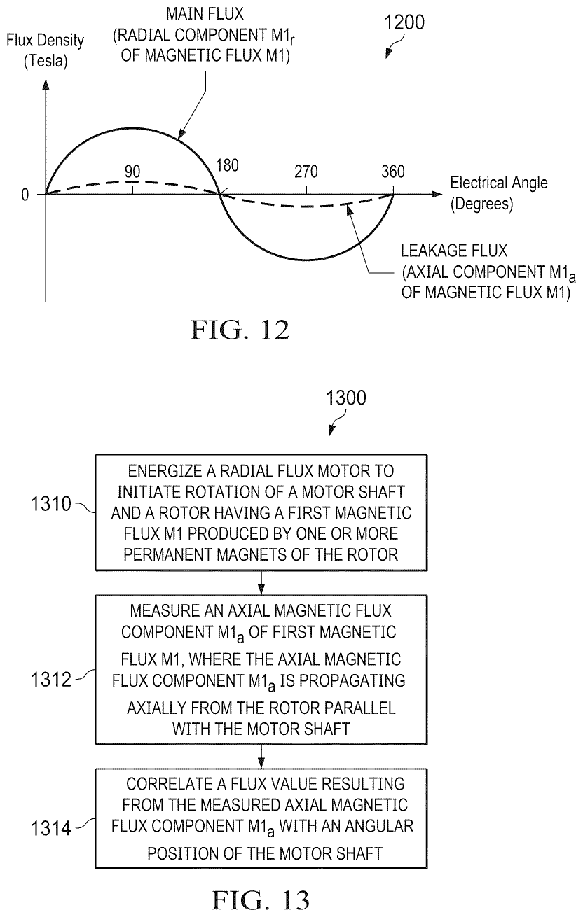

Turning to FIG. 13, a method 1300 for determining the angular position of a motor shaft of a radial flux motor is described. The method 1300 relies on the uniform nature of the first axial flux M1 produced by the rotor assembly 120 described herein and the in-phase relationship between the axial magnetic flux component M1ₐ and radial magnetic flux component M1ᵣ. In other words, the sinusoidal flux density amplitude of first magnetic flux M1 is fixed since it is produced by the rotor magnets 125 (see FIG. 5). Likewise, the axial magnetic flux component M1ₐ of first magnetic flux M1 and the radial magnetic flux component M1ᵣ of first magnetic flux M1 are fixed. The axial magnetic flux component M1ₐ of first magnetic flux M1, which is much smaller than the radial magnetic flux component M1ᵣ of first magnetic flux M1, is used to detect the rotor position since the radial and axial magnetic flux components M1ᵣ and M1ₐ of first magnetic flux M1 are electrically in phase, or, have a fixed electrical displacement with respect to one another, which in turn leads to the ability to detect the rotor position using first magnetic flux MI as described herein. Thus, in a first step 1310 of the method, a radial flux motor is energized to initiate rotation of a motor shaft and a rotor having a first magnetic flux M1 produced by one or more permanent magnets of the rotor. This rotation results in a sinusoidal first magnetic flux M1 relative to the angular position of the motor shaft as shown in FIG. 12. Moreover, the axial magnetic flux component M1ₐ of first magnetic flux M1 propagates along axially from the rotor assembly so as to be parallel with the motor shaft.

In step 1312, the axial magnetic flux component M1ₐ of first magnetic flux M1 is measured resulting in a magnetic flux value. Because this axial magnetic flux component M1ₐ of first magnetic flux M1 is propagating along the motor shaft, one or more magnetic sensors are positioned accordingly. Specifically, in order to detect axial magnetic flux component M1ₐ of first magnetic flux M1, one or more magnetic sensors are spaced axially from the rotor assembly at a radial position relative to the motor axis that is no greater than the maximum radius of the rotor assembly. This positioning minimizes the possibility that the one or more magnetic sensors will detect the axial magnetic flux component M2ₐ of second magnetic flux M2. A magnetic flux value can then be produced by measuring the axial magnetic flux component M1ₐ of first magnetic flux M1 with the one or more magnetic sensors.

In step 1314, the measured flux density of the axial magnetic flux component M1ₐ of first magnetic flux M1 is correlated to an angular position of the rotor assembly 120. The sinusoidal flux density of the axial magnetic flux component M1ₐ of first magnetic flux M1 is highest at 90 degrees and 270 degrees, while the sinusoidal flux density of the axial magnetic flux component M1ₐ of first magnetic flux M1 is smallest at 0 degrees, 180 degrees and 360 degrees. In one or more embodiments, prior to operation of the axial flux motor, to determine a particular angular position of motor shaft 110, the flux density of the axial magnetic flux component M1ₐ of first magnetic flux M1 is measured as motor shaft 110 is rotated through 360 degrees, with the angular position of the motor shaft 110 at any given time correlated to a particular flux density of the measured axial magnetic flux component M1ₐ. Thereafter, during operation of radial flux motor assembly 100 as described in step 1310, by measuring the flux density of axial magnetic flux component M1ₐ, the angular position of motor shaft 110 at any given time can be determined based on the sinusoidal nature of the magnetic flux M1 and the value resulting from the measured axial magnetic flux component M1ₐ of first magnetic flux M1.

In a step 1314, the correlating may comprise identifying along a sinusoidal curve the measured magnetic flux component M1ₐ and determining an angular value along the sinusoidal curve based the measured magnetic flux component M1ₐ where the determined angular position is representative of the angular position of the motor shaft, where axial magnetic flux component M1ₐ of first magnetic flux M1 is in phase with the radial magnetic flux component M1ᵣ of first magnetic flux M1.

In one or more embodiments of method 1300, steps may be taken to further minimize the impact of axial magnetic flux component M2ₐ of second magnetic flux M2. Thus, in step 1312, axial magnetic flux component M2ₐ of second magnetic flux M2 is shielded from the axial magnetic flux component M1ₐ of first magnetic flux M1 during measurement, thereby minimizing any interference from axial magnetic flux component M2ₐ of second magnetic flux M2 on the flux values measured by the one or more magnetic sensors.

The radial flux motor assembly as described herein has the following benefits and advantages: 1) elimination of the need for calibration because the Hall effect sensors are looking directly at the position of the permanent magnets of interest, i.e., the permanent magnets of the primary rotor assembly; 2) the stator assembly excitation does not have an impact on and interfere with the operation of the Hall effect sensors, and as a result, is not sensitive to the operating-point dependent position sensor offsets and errors; 3) the size (length) of the primary rotor assembly is decreased relative to primary rotor assemblies of prior art radial flux electric motors by eliminating the spacing necessary for the sense magnets or sense magnet rotor, thereby providing flexibility in the manufacturing of the motor; and 4) the cost of manufacture of the radial flux motor is reduced due to a drop in the part count of the bill of materials of the motor assembly, and also due to the decrease in the axial length of the primary rotor assembly.

In one or more embodiments, the proposed radial flux motor assembly utilizing the Hall effect sensor-based position feedback that eliminates the need for a sense magnet rotor is a 3 kW radial flux interior permanent magnet (“IPM”) Brushless DC Electric Motor (“BLDC”) motor. The Hall effect sensor board may be positioned in such a way that Hall effect sensors detect the axial leakage fluxes of the first magnetic flux M1 of the primary rotor assembly without interference from axial leakage fluxes of the second magnetic flux M2 of the stator assembly.

Thus, a radial flux motor assembly has been described.

Optionally, the radial flux motor assembly may include a motor housing; a motor shaft extending along a motor axis passing axially through the motor housing; a primary rotor assembly mounted on the motor shaft, the primary rotor assembly including one or more first magnets and having a first magnetic flux M1; a stator assembly mounted radially outward of the primary rotor assembly and fixed relative to the motor housing, the stator assembly including one or more second magnets and having a second magnetic flux M2; and a sensor assembly having one or more magnetic flux sensors mounted along the motor shaft and spaced axially apart from the primary rotor assembly and the stator assembly, wherein the sensor assembly is fixed relative to the motor housing to be within the first magnetic flux M1 and substantially outside of the second magnetic flux M2.

Optionally, the radial flux motor assembly may include a motor housing; a motor shaft extending along a motor axis passing axially through the motor housing; a rotor assembly mounted on the motor shaft, the rotor assembly having a plurality of permanent magnets spaced radially about the motor axis, the plurality of permanent magnets having a first magnetic flux; a stator assembly mounted radially outward of the rotor assembly and fixed relative to the motor housing, the stator assembly comprising at least one stator core disposed about the motor axis with a multiplicity of windings disposed on the stator core, the stator assembly having a second magnetic flux; and a sensor assembly mounted along the motor shaft and spaced axially apart from the rotor assembly and radially inward of the stator assembly, the sensor assembly having at least one hall effect sensor spaced radially outward from the motor axis, wherein the sensor assembly is fixed relative to the housing to be within the first magnetic flux and substantially outside of the second magnetic flux.

Optionally, the radial flux motor assembly may include a motor housing; a motor shaft extending along a motor axis passing axially through the motor housing; a primary rotor assembly mounted on the motor shaft, the primary rotor assembly including one or more first magnets and having a first magnetic flux M1; a stator assembly mounted radially outward of the primary rotor assembly and fixed relative to the motor housing, the stator assembly including one or more second magnets and having a second magnetic flux M2; and a sensor assembly mounted along the motor shaft and spaced axially apart from the primary rotor assembly and the stator assembly, wherein the sensor assembly is fixed relative to the motor housing to be within the first magnetic flux M1 and substantially outside of the second magnetic flux M2.

Optionally, the radial flux motor assembly may include a motor housing; a motor shaft extending along a motor axis passing axially through the motor housing; a rotor assembly mounted on the motor shaft, the rotor assembly having a plurality of permanent magnets spaced radially about the motor axis, the plurality of permanent magnets having a first magnetic flux; a stator assembly mounted radially outward of the rotor assembly and fixed relative to the motor housing, the stator assembly comprising a stator core disposed about the motor axis with a multiplicity of winding disposed on the stator core, the stator assembly having a second magnetic flux; and a sensor assembly mounted along the motor shaft and spaced axially apart from the rotor assembly and stator assembly, the sensor assembly having at least two hall effect sensors spaced apart from one another circumferentially about the motor axis, wherein the sensor assembly is fixed relative to the housing to be within the first magnetic flux and substantially outside of the second magnetic flux.

Optionally, the radial flux motor assembly may include a motor housing; a motor shaft extending along a motor axis passing axially through the motor housing; a rotor assembly mounted on the motor shaft, the rotor assembly having a plurality of permanent magnets spaced radially about the motor axis, the plurality of permanent magnets having a first magnetic flux; a stator assembly mounted radially outward of the rotor assembly and fixed relative to the motor housing, the stator assembly comprising a stator core disposed about the motor axis with a multiplicity of winding disposed on the stator core, the stator assembly having a second magnetic flux; and a sensor assembly mounted along the motor shaft and spaced axially apart from the rotor assembly and stator assembly, the sensor assembly having at least two Hall effect sensors spaced apart from one another circumferentially about the motor axis, wherein the sensor assembly is fixed relative to the housing to be within the first magnetic flux and outside of the second magnetic flux.

Any of the foregoing radial flux motor assemblies may further include, alone or in combination, any of the following:
The primary rotor assembly comprises one or more permanent magnets spaced radially about the motor axis at a radius R1.
The primary rotor assembly comprises a plurality of permanent magnets spaced radially about the motor axis.
The stator assembly comprises one or more electromagnets spaced radially about the motor axis at a radius R2.
The stator assembly comprises a plurality of electromagnets.
The stator assembly comprises a plurality of coils of wire, each of the plurality of coils of wire being positioned on a core.
The sensor assembly comprises at least one Hall effect sensor spaced radially outward from motor axis at a radius R3.
The sensor assembly comprises at least two Hall effect sensors spaced apart from one another circumferentially about the motor axis.
The sensor assembly comprises at least three Hall effect sensors spaced apart from one another circumferentially about the motor axis.
The sensor assembly comprises three Hall effect sensors spaced apart from one another circumferentially about the motor axis by an angle α.
The axial flux motor assembly is a three-phase electric motor.
Angle α is 60 electrical degrees.
Angle α is 120 electrical degrees.
The sensor assembly includes a printed circuit board having three Hall effect sensors spaced apart from one another circumferentially about the motor axis by 120 electrical degrees; and at least two stand-offs extending from the motor housing and on which the printed circuit board is mounted.
Magnetic flux shielding positioned about the motor shaft, spaced apart from the rotor assembly, and adjacent the stator assembly to minimize axial magnetic flux from the stator assembly.
The magnetic flux shielding is disposed radially outward from the sensor assembly.
The sensor assembly is spaced apart from the stator assembly an axial distance D1 selected so that the sensor assembly is outside of the second magnetic flux.
The sensor assembly is spaced apart from the stator assembly an axial distance D1 selected so that the sensor assembly exposure to the second magnetic flux is minimized.
The primary rotor assembly further comprises one or more permanent magnets spaced radially about the motor axis at a radius R1; the stator assembly further comprises one or more electromagnets spaced radially about the motor axis at a radius R2; and the sensor assembly comprises three Hall effect sensors spaced apart from one another circumferentially about the motor axis at a radius R3.
R3 is greater than R1.
R2 is less than R1.
The one or more first magnets of the primary rotor assembly comprise permanent magnets spaced radially about the motor axis and the primary rotor assembly has an outer radius R1.
The one or more second magnets of the stator assembly comprise electromagnets spaced radially about the motor axis at a radius R3 which radius R3 is greater than radius R1.
The one or more second magnets comprise a plurality of coils of wire, each of the plurality of coils of wire being positioned on a core.
The sensor assembly comprises at least one Hall effect sensor spaced radially outward from motor axis at a radius R2.
The sensor assembly comprises at least two Hall effect sensors spaced apart from one another circumferentially about the motor axis.
The sensor assembly comprises three Hall effect sensors, each spaced apart from one another circumferentially about the motor axis by α electrical degrees.
The axial flux motor assembly is a three-phase electric motor.
The one or more magnetic flux sensors are mounted radially inward of the stator assembly.
Magnetic flux shielding disposed radially outward from the one or more magnetic flux sensors.
The magnetic flux shielding is a sleeve formed of a high magnetic permeability material.
The sensor assembly comprises a printed circuit board on which the one or more magnetic flux sensors are supported; and at least two stand-offs extending from the motor housing, wherein the printed circuit board is mounted on the at least two stand-offs so that the printed circuit board is adjacent the primary rotor assembly.
The sensor assembly comprises two hall effect sensors spaced apart from one another circumferentially about the motor axis.
The sensor assembly is spaced apart from the stator assembly an axial distance D1, where D1 is between 5 to 15 millimeters.
The sensor assembly comprises a printed circuit board on which the two hall effect sensors are supported; and at least two stand-offs extending from the motor housing, wherein the printed circuit board is mounted on the at least two stand-offs so that the printed circuit board is adjacent the primary rotor assembly.
Magnetic flux shielding disposed radially outward from the at least one hall effect sensor and radially inward of the stator assembly.

A method for operating a radial flux motor has been described.

Optionally, the method for operating a radial flux motor includes energizing a radial flux motor to initiate rotation of a motor shaft and a rotor having a first magnetic flux M1 produced by one or more permanent magnets of the rotor; measuring an axial magnetic flux component M1ₐ of first magnetic flux M1, where the axial magnetic flux component M1ₐ is propagating axially from the rotor parallel with the motor shaft; and correlating a flux value resulting from the measured axial magnetic flux component M1ₐ with an angular position of the motor shaft.

Optionally, the method for operating a radial flux motor includes positioning a rotor assembly having a first magnetic flux within a stator assembly; energizing the coils of the stator assembly to produce a second magnetic flux; positioning a Hall effect sensor along a motor axis extending axially through the rotor assembly and stator assembly; utilizing the Hall effect sensor to measure a first magnetic flux value and a second magnetic flux value axially along the motor axis; and adjusting the position of the Hall effect sensor axially along the motor axis until the second axial flux value is less than the first axial flux value.

Any of the foregoing radial flux motor operation methods may further include, alone or in combination, any of the following:
Correlating comprises utilizing a sinusoidal curve of the magnetic flux M1 and known angular position of the motor shaft at any point along the sinusoidal curve, where axial magnetic flux component M1ₐ of first magnetic flux M1 is in phase with the radial magnetic flux component M1ᵣ of first magnetic flux M1.
The flux value of the axial magnetic flux component M1ₐ along the sinusoidal curve is highest at 90 degrees and 270 degrees and smallest at 0 degrees, 180 degrees and 360 degrees.
Producing a second magnetic flux M2 by one or more second magnets of a stator, wherein the second magnetic flux M2 has an axial magnetic flux component M2a propagating axially from the stator and parallel with the motor shaft; and shielding the axial magnetic flux component M1ₐ of first magnetic flux M1 from the axial magnetic flux component M2ₐ of second magnetic flux M2.
Energizing the coils of a stator assembly to produce a second magnetic flux.
Positioning a Hall effect sensor along a motor axis extending axially through the rotor assembly and stator assembly.
Utilizing the Hall effect sensor to measure a first magnetic flux value and a second magnetic flux value axially along the motor axis.
Adjusting the position of the Hall effect sensor axially along the motor axis until the second axial flux value is less than the first axial flux value.
Adjusting the position of the Hall effect sensor axially along the motor axis until the second axial flux value is substantially zero.
Fixing the Hall effect sensor along the motor axis once the measured first axial flux value is less than the second axial flux value.

Although several embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A radial flux motor assembly, comprising:
a motor housing;
a motor shaft extending along a motor axis passing axially through the motor housing;
a primary rotor assembly mounted on the motor shaft, the primary rotor assembly including one or more first magnets and having a first magnetic flux M1;
a stator assembly mounted radially outward of the primary rotor assembly and fixed relative to the motor housing, the stator assembly including one or more second magnets and having a second magnetic flux M2; and
a sensor assembly having one or more magnetic flux sensors mounted along the motor shaft and spaced axially apart from the primary rotor assembly and the stator assembly, wherein the sensor assembly is fixed relative to the motor housing to be within the first magnetic flux M1 and substantially outside of the second magnetic flux M2.

2. The motor assembly of claim 1, wherein the one or more first magnets of the primary rotor assembly comprise permanent magnets spaced radially about the motor axis and the primary rotor assembly has an outer radius R1.

3. The motor assembly of claim 2, wherein the one or more second magnets of the stator assembly comprise electromagnets spaced radially about the motor axis at a radius R3 which radius R3 is greater than radius R1.

4. The motor assembly of claim 3, wherein the one or more second magnets comprise a plurality of coils of wire, each of the plurality of coils of wire being positioned on a core.

5. The motor assembly of claim 1, wherein the sensor assembly comprises at least one Hall effect sensor spaced radially outward from motor axis at a radius R2.

6. The motor assembly of claim 5, wherein the sensor assembly comprises at least two Hall effect sensors spaced apart from one another circumferentially about the motor axis.

7. The motor assembly of claim 1, wherein the sensor assembly comprises three Hall effect sensors, each spaced apart from one another circumferentially about the motor axis by α electrical degrees.

8. The motor assembly of claim 8, wherein the axial flux motor assembly is a three-phase electric motor.

9. The motor assembly of claim 1, wherein the one or more magnetic flux sensors are mounted radially inward of the stator assembly.

10. The motor assembly of claim 1, further comprising magnetic flux shielding disposed radially outward from the one or more magnetic flux sensors.

11. The motor assembly of claim 10, wherein the magnetic flux shielding is a sleeve formed of a high magnetic permeability material.

12. The motor assembly of claim 1,
wherein the sensor assembly comprises:
a printed circuit board on which the one or more magnetic flux sensors are supported; and
at least two stand-offs extending from the motor housing, wherein the printed circuit board is mounted on the at least two stand-offs so that the printed circuit board is adjacent the primary rotor assembly.

13. A radial flux motor assembly comprising:
a motor housing;
a motor shaft extending along a motor axis passing axially through the motor housing;
a rotor assembly mounted on the motor shaft, the rotor assembly having a plurality of permanent magnets spaced radially about the motor axis, the plurality of permanent magnets having a first magnetic flux;
a stator assembly mounted radially outward of the rotor assembly and fixed relative to the motor housing, the stator assembly comprising at least one stator core disposed about the motor axis with a multiplicity of windings disposed on the stator core, the stator assembly having a second magnetic flux; and
a sensor assembly mounted along the motor shaft and spaced axially apart from the rotor assembly and radially inward of the stator assembly, the sensor assembly having at least one hall effect sensor spaced radially outward from the motor axis, wherein the sensor assembly is fixed relative to the housing to be within the first magnetic flux and substantially outside of the second magnetic flux.

14. The motor assembly of claim 13, wherein the sensor assembly comprises two hall effect sensors spaced apart from one another circumferentially about the motor axis.

15. The motor assembly of claim 13, wherein the sensor assembly is spaced apart from the stator assembly an axial distance D1, where D1 is between 5 to 15 millimeters.

16. The motor assembly of claim 14, wherein the sensor assembly comprises:
a printed circuit board on which the two hall effect sensors are supported; and
at least two stand-offs extending from the motor housing, wherein the printed circuit board is mounted on the at least two stand-offs so that the printed circuit board is adjacent the primary rotor assembly.

17. The motor assembly of claim 13, further comprising magnetic flux shielding disposed radially outward from the at least one hall effect sensor and radially inward of the stator assembly.

18. A method for determining the angular position of a motor shaft of a radial flux motor, the method comprising:
energizing a radial flux motor to initiate rotation of a motor shaft and a rotor having a first magnetic flux M1 produced by one or more permanent magnets of the rotor;
measuring an axial magnetic flux component M1ₐ of first magnetic flux M1, where the axial magnetic flux component M1ₐ is propagating axially from the rotor parallel with the motor shaft; and
correlating a flux value resulting from the measured axial magnetic flux component M1ₐ with an angular position of the motor shaft.

19. The method of claim 18, wherein correlating comprises utilizing a sinusoidal curve of the magnetic flux M1 and known angular position of the motor shaft at any point along the sinusoidal curve, where axial magnetic flux component M1ₐ of first magnetic flux M1 is in phase with the radial magnetic flux component M1ᵣ of first magnetic flux M1.

20. The method of claim 19, wherein flux value of the axial magnetic flux component M1ₐ along the sinusoidal curve is highest at 90 degrees and 270 degrees and smallest at 0 degrees, 180 degrees and 360 degrees.

21. The method of claim 19, further comprising producing a second magnetic flux M2 by one or more second magnets of a stator, wherein the second magnetic flux M2 has an axial magnetic flux component M2ₐ propagating axially from the stator and parallel with the motor shaft; and shielding the axial magnetic flux component M1ₐ of first magnetic flux M1 from the axial magnetic flux component M2ₐ of second magnetic flux M2.
